(19) United States
(12) Patent Application Publication
(10) Pub. No.: US 2012/0157726 A1
(43) Pub. Date: Jun. 21, 2012

(54) Process For The Production Of Cellulose Based Biofuels

(75) Inventors: Dennis A. Vauk, Houston, TX (US); Tarun D. Vakil, Allentown, PA (US)

(73) Assignee: Air Liquide Large Industries U.S. LP, Houston, TX (US)

(21) Appl. No.: 12/969,038

(22) Filed: Dec. 15, 2010

(51) Int. Cl. C10G 1/00; C01B 3/02

(52) U.S. Cl. 585/240

(57) ABSTRACT

A process for the production of cellulose based biofuels is provided. This process includes pyrolysing a cellulose-containing feedstock to form a slurry of bioliquids and char; hydrocracking the slurry to produce a hydrocarbon gas stream, a hydrocarbon liquid stream, an impurities stream, and a residue stream; distilling the liquid hydrocarbon stream to produce at least a naphtha stream, and a diesel stream; and gasifying the residue stream to produce at least a hydrogen and a carbon monoxide stream.

### BACKGROUND

Biofuels are a wide range of fuels which are in some way derived from biomass. The term covers solid biomass, liquid fuels and various biogases. Biofuels are gaining increased public and scientific attention, driven by factors such as oil price spikes, the need for increased energy security, and concern over greenhouse gas emissions from fossil fuels.

Bioethanol is an alcohol made by fermenting the sugar components of plant materials and it is made mostly from sugar and starch crops. With advanced technology being developed, cellulosic biomass, such as trees and grasses, are also used as feedstocks for ethanol production. Ethanol can be used as a fuel for vehicles in its pure form, but it is usually used as a gasoline additive to increase octane and improve vehicle emissions. Bioethanol is widely used in the USA and in Brazil.

Biodiesel is made from vegetable oils, animal fats or recycled greases. Biodiesel can be used as a fuel for vehicles in its pure form, but it is usually used as a diesel additive to reduce levels of particulates, carbon monoxide, and hydrocarbons from diesel-powered vehicles. Biodiesel is produced from oils or fats using transesterification and is the most common biofuel in Europe.

‘First-generation biofuels’ are biofuels made from sugar, starch, vegetable oil, or animal fats using conventional technology. Often, first-generation biofuels are produced by fermenting plant-derived sugars to ethanol, using a similar process to that used in beer and wine-making. The basic feedstocks for the production of first generation biofuels are often seeds or grains such as sunflower seeds, which are pressed to yield vegetable oil that can be used in biodiesel, or wheat, which yields starch that is fermented into bioethanol. These feedstocks could instead enter the animal or human food chain, and as the global population has risen their use in producing biofuels has been criticized for diverting food away from the human food chain, leading to food shortages and price rises.

This typically requires the use of ‘food’ crops such as sugar cane, corn, wheat, and sugar beet. These crops are required for food, so if too much biofuel is made from them, food prices could rise and shortages might be experienced in some countries. Corn, wheat and sugar beet also require high agricultural inputs in the form of fertilizers, which limit the greenhouse gas reductions that can be achieved.

Second generation biofuel technologies have been developed because first generation biofuels manufacture has important limitations. First generation biofuel processes are useful, but limited in most cases: there is a threshold above which they cannot produce enough biofuel without threatening food supplies and biodiversity. Many first generation biofuels are dependent of subsidies and are not cost competitive with existing fossil fuels such as oil, and some of them produce only limited greenhouse gas emissions savings. When taking emissions from production and transport into account, life cycle assessment from first-generation biofuels frequently exceed those of traditional fossil fuels.

Second generation biofuels can help solve these problems and can supply a larger proportion of our fuel supply sustainably, affordably, and with greater environmental benefits.

The goal of second generation biofuel processes is to extend the amount of biofuel that can be produced sustainably by using biomass consisting of the residual non-food parts of current crops, such as stems, leaves and husks that are left behind once the food crop has been extracted, as well as other crops that are not used for food purposes (non food crops), such as switch grass, jatropha and cereals that bear little grain, and also industry waste such as woodchips, skins and pulp from fruit pressing, etc.

The problem that second generation biofuel processes are addressing is to extract useful feedstocks from this woody or fibrous biomass, where the useful sugars are locked in by lignin and cellulose. All plants contain cellulose and lignin. These are complex carbohydrates (molecules based on sugar). Lignocellulosic ethanol is made by freeing the sugar molecules from cellulose using enzymes, steam heating, or other pre-treatments. These sugars can then be fermented to produce ethanol in the same way as first generation bioethanol production. The by-product of this process is lignin. Lignin can be burned as a carbon neutral fuel to produce heat and power for the processing plant and possibly for surrounding homes and businesses.

### SUMMARY

A process for the production of cellulose based biofuels is provided. This process includes pyrolysing a cellulose-containing feedstock to form a slurry of bioliquids and char; hydrocracking the slurry to produce a hydrocarbon gas stream, a hydrocarbon liquid stream, an impurities stream, and a residue stream; distilling the liquid hydrocarbon stream to produce at least a naphtha stream, and a diesel stream; and gasifying the residue stream to produce at least a hydrogen and a carbon monoxide stream.

### BRIEF DESCRIPTION OF THE FIGURES

FIG. 1 illustrates one embodiment of the present invention illustrating the pyrolysis unit, the two step hydrocracker, and the gasification unit.

FIG. 2 illustrates one embodiment of the present invention illustrating the two step hydrocracker and the distillation unit.

FIG. 3 illustrates one embodiment of the present invention illustrating the gasification unit and the downstream syngas treatment.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The subject of the invention is a process for production of cellulose based biofuels. This invention is also applicable to other solid hydrocarbon based fuels such as lignite, coal etc. dissolved in solvents or liquefied under appropriate process conditions of pressure and temperature.

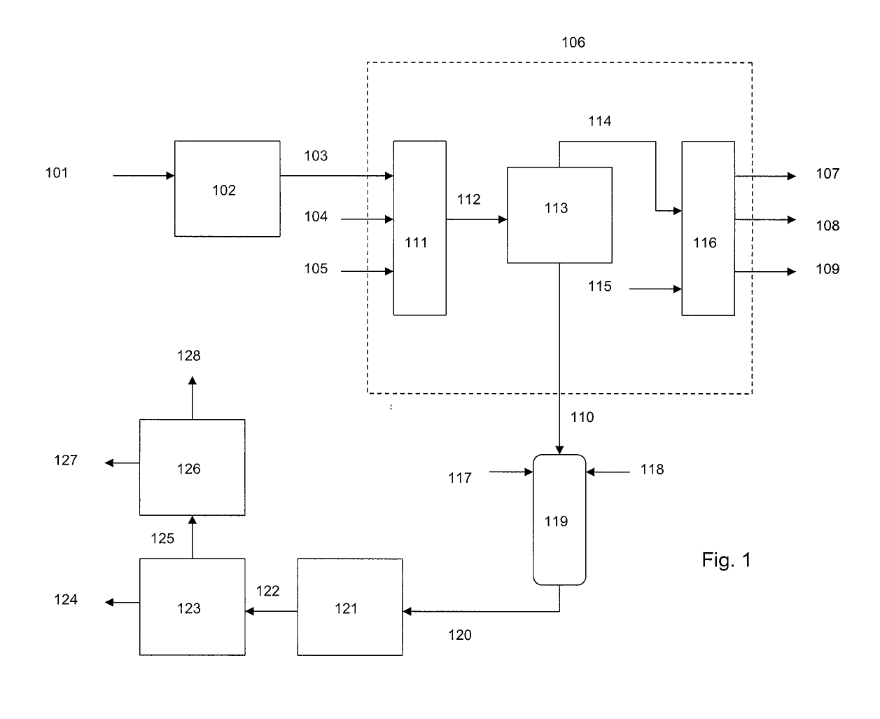

Turning to the sole figure, FIG. 1, the process basically consists of three primary steps: 1) pyrolysis 102 of cellulose 101 to form of slurry of “bioliquids” and char 103; 2) hydrocracking 106 of the bioliquid slurry 103 in a two step slurry hydrocracker 111 followed by a fixed bed hydrocracker 116; and 3) gasification 119 of a residue 110 by combining with oxygen 117 and steam 118 at high temperature to form syngas 120.

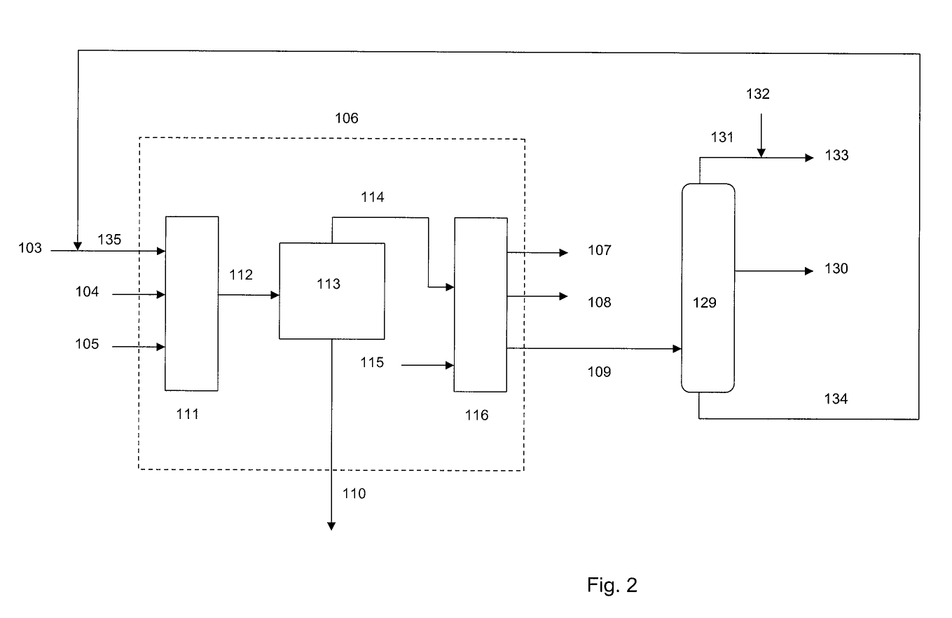

Turning to FIG. 2, in the interest of clarity, all stream numbers are consistent between the two Figures. During a subsequent distillation step, the hydrocracking results are further separated into four product streams: 1) a naphtha stream 131 which may be blended with a bio-ethanol stream 132 to form a E-85 grade gasoline stream 133; a diesel stream 130; a vacuum gas oil stream 134 that may be circulated back and blended with fixed bed hydrocracker feed stream 135; and a residue stream 136.

The syngas stream 120 is then shifted 121 to produce a hydrogen-enriched stream 122. A carbon dioxide stream 124 is removed from the hydrogen-enriched stream 122, typically in an acid gas removal process 123, before final purification, for instance in a PSA (pressure swing adsorption) 126. The PSA 126 produces a high purity hydrogen stream 128 and a reject stream 127.

The process will now be discussed in further detail. A cellulose containing stream 101 is pyrolized to form a slurry of bioliquids and char 103. This pyrolisis may be performed in a Lurgi “sand coker” or similar apparatus known to the skilled artisan. The slurry 103 is then hydrocracked in a two step hydrocracker 106 with the following process steps. First, a hydrogen stream 104, the slurry 103, and an additive stream 105, such as lignite coke or iron sulfide, are combined. Next the slurry mixture is heated to reaction temperature. At this time, additional hydrogen is heated to a higher temperature (not shown). The slurry mixture 103, 104, 105 (or liquefied/dissolved solid hydrocarbon feed stocks included) are introduced into a reactor 111 where the additive, hydrogen and slurry react to form hydrocarbons with lower carbon chain length (hydrocracking). This process may be one known to the art such as Veba Combi-Cracker, Canmet Slurry Hydrocracker, ENI EST process or a similar process. This slurry hydrocracker may be an ebulated bed hydrocracker such as H-Oil or LC Finer.

Next the residue products 110 and the additive are separated from vacuum distillates, diesel, naphtha, light gases and hydrogen (collectively overhead product 114) in a hot separator 113. The overhead product 114 of the hot separator of 113 is then directed through a fixed bed hydrocracker 116 containing a combination of hydrotreating and hydrocracking catalytic functions. In this second hydrocracker the following reactions will occur. The combining of hydrogen with oxygen containing compounds to form water and hydrocarbons. The saturation of olefinic compounds with hydrogen to form hydrocarbons. The combining hydrogen with sulfur containing compounds to form hydrogen sulfide and hydrocarbons. The hydrocracking of heavier compounds in the vacuum gas oil boiling range (360-550 C boiling point) to form gasoline and diesel range lighter hydrocarbons.

Hydrogen 115 is typically introduced at various points into the fixed bed hydrocracker to cool down the reactants, thereby controlling the rate of the reaction. The stream is cooled down and the liquid hydrocarbons 109 are separated from the hydrogen and lighter hydrocarbons 130, as well as any impurities such as ammonia or sulfur 107.

The liquid hydrocarbon stream 109 is then introduced into a distillation column 129, where liquid products of are fractionated to separate them into naphtha (C5-130 C) 131, diesel (130-360 C) 130, and vacuum gas oil products (360 C Plus) 134. The naphtha fraction 131 is blended with bio-ethanol 132 to produce E-85 grade gasoline 133 typically using the ratio of 15% naphtha and 85% bioethanol. The vacuum gas oil fraction 134 is recycled back to the fixed bed hydrocracking reactor 111.

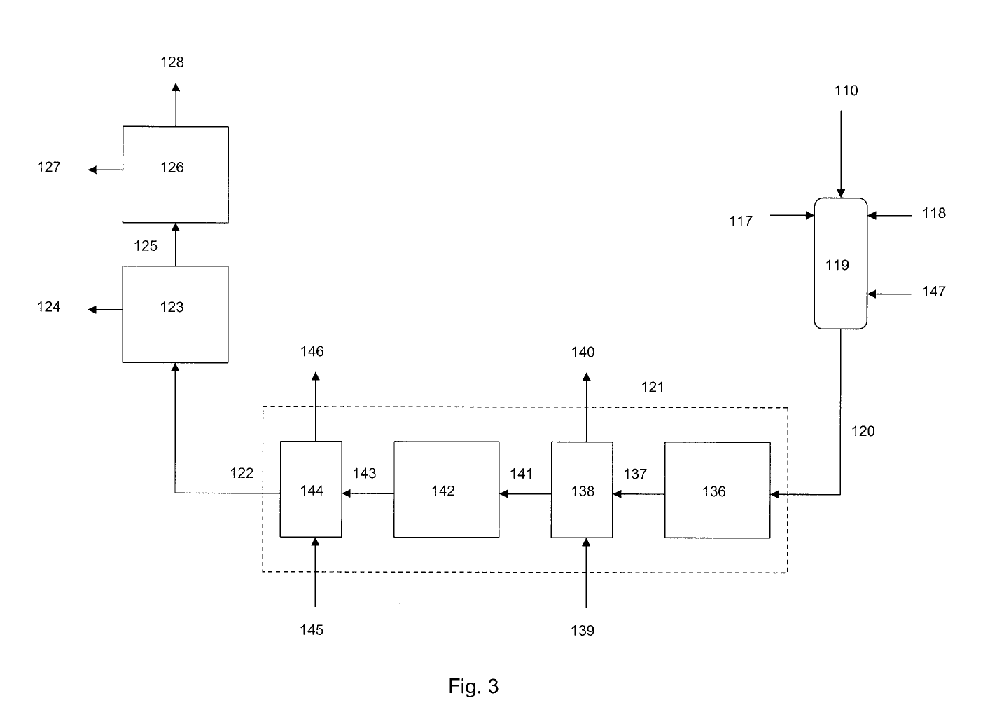

Turning to FIG. 3, in the interest of clarity, all stream numbers are consistent between the two Figures. The residue and additive fraction 110 are combined with steam 118 and oxygen 117 and feed to an entrained flow gasifier 119 to make a syngas 120 consisting of carbon monoxide and hydrogen. The syngas is cooled by introducing quench water 147. The syngas is shifted in a first shift reactor 136 by contacting with catalyst to promote the reaction of carbon monoxide and steam to form hydrogen. The first shifted stream 137 is cooled down by introduction into a first waste heat steam generator 138, wherein boiler feed water 139 is heated to generate steam 140. The cooled syngas 141 is introduced into a second shift reactor 142 to produce a second shifted stream 143 with the ratio of 90-99% hydrogen per 1-10% carbon monoxide. This second shifted stream 143 is cooled down by introduction into a second waste heat steam generator 144, wherein boiler feed water 145 is heated to generate steam 146. The carbon dioxide and hydrogen sulfide is removed from the second cooled syngas stream 122 in an acid gas removal system 123, using one of the following processes; MDEA amine contacting, Rectisol, Selexol, or DGA solvent contacting. Finally, a Pressure Swing Adsorption (PSA) 126 is used to produce 99.9% hydrogen 128 and a PSA tail gas 127 consisting of residual nitrogen, Carbon Monoxide, methane, argon and some hydrogen. A portion of the hydrogen produced may be compressed and introduction into the hydrocracking steps.

What is claimed is:

1. A process for the production of cellulose based biofuels, comprising;
pyrolysing a cellulose-containing feedstock to form a slurry of bioliquids and char;
hydrocracking said slurry to produce a hydrocarbon gas stream, a hydrocarbon liquid stream, an impurities stream, and a residue stream;
distilling said liquid hydrocarbon stream to produce at least a naphtha stream, and a diesel stream; and
gasifying said residue stream to produce at least a hydrogen and a carbon monoxide stream.

2. The process of claim 1, wherein said cellulose-containing feedstock is selected from the group consisting of sugar cane, straw, hay, wood chips, bamboo, and grasses.

3. The process of claim 1, wherein said hydrocracking further comprises:
introducing said slurry into a slurry hydrocracker, along with a hydrogen stream and an additive stream, thereby producing hydrocracking product,
separating said hydrocracking product, in a hot separator, into said residue stream and an overhead stream;
introducing said overhead stream into a fixed bed hydrocracker, along with a hydrogen stream, thereby producing said hydrocarbon gas stream, said hydrocarbon liquid stream and said impurities stream.

4. The process of claim 3, wherein said additive is lignite coke or iron sulfide.
